(19) United States
(12) Patent Application Publication
(10) Pub. No.: US 2013/0167019 A1
(43) Pub. Date: Jun. 27, 2013

(54) INFORMATION-PROCESSING DEVICE AND CONTROL METHOD FOR INFORMATION-PROCESSING DEVICE

(71) Applicants: Minoru Wadayama, Osaka-shi (JP); Kohji Akasaka, Osaka-shi (JP); Hiroshi Fukutomi, Osaka-shi (JP)

(72) Inventors: Minoru Wadayama, Osaka-shi (JP); Kohji Akasaka, Osaka-shi (JP); Hiroshi Fukutomi, Osaka-shi (JP)

(73) Assignee: SHARP KABUSHIKI KAISHA, Osaka-shi, Osaka (JP)

(21) Appl. No.: 13/819,434

(22) PCT Filed: Oct. 11, 2011
(86) PCT No.: PCT/JP2011/073348

§ 371 Date: Feb. 27, 2013

(30) Foreign Application Priority Data
Oct. 15, 2010 (JP) 2010-233002

(51) Int. Cl. G06F 17/21

(52) U.S. Cl. CPC G06F 17/217
USPC 715/251

(57) ABSTRACT

An electronic notebook device (100) disclosed includes: a state shifting section (11) for accepting deletion mode shift gesture information indicative of a gesture performed in a direction along, among the sides of a page displayed, a side on which the page is bound; and a page deleting section (14) for deleting page information for the currently display page in the case where after the state shifting section (11) has accepted the deletion mode shift gesture information, a deletion accepting section (13) has accepted gesture information indicative of a gesture performed in a direction away from the page binding side.

### TECHNICAL FIELD

The present invention relates to (i) an information processing device that displays electronic information as a page and (ii) a method for controlling an information processing device.

### BACKGROUND ART

There have been developed, along with increasingly widespread use of computers, various user interfaces allowing a user to operate a computer more intuitively. In particular, recent years have witnessed a large number of proposed user interfaces in the field of a technique by which information that has been provided in the form of a paper medium is converted to electronic form for information provision.

Patent Literature 1, for example, discloses a technique for displaying electronic information as a page. Specifically, Patent Literature 1 proposes a user interface that carries out a page turning process in response to an operation on a touch panel or the like to allow the user to experience, from display of electronic information as a page, a feeling of reading an actual book when interacting with the user interface.

### CITATION LIST

### Patent Literature 1

Japanese Patent Application Publication, Tokukai, No. 2004-288208 A (Publication Date: Oct. 14, 2004)

### SUMMARY OF INVENTION

### Technical Problem

The technique disclosed in Patent Literature 1, however, simply provides a user interface for viewing information, and thus merely allows the user to experience a feeling of reading an actual book when electronic information prepared in advance is presented as a page. Patent Literature 1 thus makes no mention of a user interface for editing electronic information presented as a page.

The user interface disclosed in Patent Literature 1 thus fails to consider editing electronic information presented as a page. Patent Literature 1 consequently fails to discuss convenience that is to be offered to the user when the user performs an operation of, for example, adding or deleting a page.

The present invention has been accomplished in view of the above problem. It is an object of the present invention to provide (i) an information processing device that provides a user interface that is convenient for the user in performing a process of adding or deleting a page when the information processing device is displaying electronic information to be presented as a page, and (ii) a method for controlling an information processing device.

### Solution to Problem

In order to solve the above problem, an information processing device of the present invention is an information processing device for, in response to an input operation performed with respect to a touch panel integrated with a display section, displaying electronic information as a page in the display section, the information processing device including: input operation detecting means for detecting an input operation performed with respect to a vicinity of, among sides of the page of the electronic information displayed, a side on which the page is bound; and page processing means for carrying out a process of either page addition or page deletion in a case where after the input operation detecting means has detected the input operation, the page processing means has detected a predetermined input operation.

In order to solve the above problem, a method of the present invention for controlling an information processing device is a method for controlling an information processing device for, in response to an input operation performed with respect to a touch panel integrated with a display section, displaying electronic information as a page in the display section, the method including the steps of: (a) detecting an input operation performed with respect to a vicinity of, among sides of the page of the electronic information displayed, a first side on which the page is bound; and (b) carrying out a process of either page addition or page deletion in a case where after the step (a) has detected the input operation, a predetermined input operation has been detected.

The above arrangements each first detect an input operation performed with respect to the vicinity of, among the sides of a page of electronic information displayed, the side on which the page is bound.

The above input operation refers to an operation that can be recognized on a touch panel. Examples of the input operation include a click, a flick, a drag, and a swipe.

In the case where the information processing device displays electronic information as a page in the display section, the page displayed has a side representative of the side on which the page is bound. The expression “representative of the side on which the page is bound” means displaying an image that imitates the side of a paper notebook or book on which side the individual pages are bound.

The information processing device displays pages that imitate those of a paper notebook or book, and can thus provide an intuitive user interface.

The input operation performed with respect to the vicinity of the side on which the page is bound is representative of the action of releasing a bound page from a binding section. There are more than one feasible technique for releasing a bound page from a binding section. In other words, the technique varies depending on the method for binding a page. No matter what technique is used, however, an operation of some sort will be performed with respect to the page binding side.

For instance, one way to cut a page off a bound book as a paper medium is cutting, with use of a cutting tool or the like, the target page along the side on which that page is bound. The input operation performed with respect to the vicinity of the side on which the page is bound is thus, for example, an input operation performed in the direction along the page binding side.

The input operation performed in the direction along the page binding side, stated differently, corresponds to the action of tracing the gutter of a paper notebook or book at which gutter the individual pages are bound, and is a gesture of cutting a portion of a page at which portion the page is joined to the rest.

As another example, to replace loose leaves in a loose-leaf notebook, a ring-shaped fastening is opened with use of levers provided at the respective ends of the fastening.

The input operation performed with respect to the vicinity of the side on which the page is bound can thus be, for example, an input operation performed with respect to the ends of the page binding side. The “ends” may refer to both of the ends of the page binding side or to one of the ends of the page binding side.

In other words, the input operation performed with respect to the ends of the page binding side is representative of an operation of levers of a loose-leaf notebook.

The above input operations each suggest influencing a page in its entirety, particularly removing and inserting a page, and are thus convenient for the user in experiencing a sense of starting a process on a page in its entirety such as addition and deletion of a page.

The above arrangements, after detecting an input operation performed with respect to the vicinity of the side on which the page is bound, that is, after detecting a gesture of cutting a portion of a page at which portion the page is joined to the rest, each carry out a process of page addition or page deletion in the case where a predetermined input operation has been detected.

The predetermined input operation is, for example, an operation so set in advance as to start a process of page addition or page deletion, and is not particularly limited in arrangement. The predetermined input operation may be an operation that allows the user to experience a sense of (i) moving a page from the notebook body, (ii) adding or deleting a page to or from the notebook body, or (iii) replacing pages.

The predetermined input operation may be, as another example, an input operation performed in a direction substantially perpendicular to the page binding side. The input operation performed in a direction substantially perpendicular to the page binding side is representative of the action of (i) tearing a page off a paper notebook or book in the direction away from the page binding side or (ii) inserting a page in a paper notebook or book. The direction substantially perpendicular to the page binding side may thus have a variation range within which an input operation is recognized as having been performed with the intention of performing the gesture of (i) tearing a page away from the page binding side or (ii) inserting a page.

The process of page addition or page deletion is, to be specific, a process of (i) deleting electronic information for the currently display page or (ii) adding a new page. The process of page addition or page deletion additionally includes a process of temporarily removing the currently display page and adding the removed page to another position.

The above arrangements, which can carry out a process of page addition or page deletion in response to an input operation described above, each allow the user to experience, in operating the information processing device, a feeling of actually inserting or removing a page to or from a paper notebook or book.

As described above, the information processing device is arranged to add or delete a page in response to (i) a gesture of separating a page by cutting a portion of the page at which portion the page is joined to the rest and (ii) an input operation performed subsequently to the above gesture in a direction substantially perpendicular to the page binding side. This can provide a user interface that allows the user to delete a page through an intuitive operation similar to the action of actually inserting or removing a page to or from a paper notebook or book.

In addition, the above arrangements, which provide a user interface that allows the user to perform an operation of page deletion through two steps as described above, also each advantageously prevent the user from accidentally performing an unintended process. The above arrangements can, for instance, prevent the user from deleting a page by mistake.

### Advantageous Effects of Invention

An information processing device of the present invention includes: input operation detecting means for detecting an input operation performed with respect to a vicinity of, among sides of the page of the electronic information displayed, a first side on which the page is bound; and page processing means for carrying out a process of either page addition or page deletion in a case where after the input operation detecting means has detected the input operation, the page processing means has detected a predetermined input operation.

A method of the present invention for controlling an information processing device includes the steps of: (a) detecting an input operation performed with respect to a vicinity of, among sides of the page of the electronic information displayed, a first side on which the page is bound; and (b) carrying out a process of either page addition or page deletion in a case where after the step (a) has detected the input operation, a predetermined input operation has been detected.

The above arrangements can each provide a user interface that allows the user to add or delete a page through an intuitive operation similar to the action of actually inserting or removing a page to or from a paper notebook or book.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram illustrating an example configuration of an electronic notebook device of an embodiment of the present invention.

FIG. 2 is a data structure diagram illustrating an example data structure of electronic notebook information.

FIG. 3 is a diagram illustrating an example display of page information for the first page of an electronic notebook.

FIG. 4 is a diagram illustrating an example display of page information for the second page of an electronic notebook.

FIG. 5 is a diagram illustrating a toolbox that holds a collection of editing functions for an electronic notebook.

FIG. 6 is a diagram illustrating an example display of page information for the first page of an electronic notebook.

FIG. 7 is a diagram illustrating an example display in a deletion mode.

FIG. 8 is a diagram illustrating example case of deleting page information for the first page of an electronic notebook.

FIG. 9 is a diagram illustrating an example display effect produced when page information for the first page of an electronic notebook is to be deleted.

FIG. 10 is a diagram illustrating example case of deleting page information for the second page of an electronic notebook.

FIG. 11 is a diagram illustrating an example state in which page information for the second page of an electronic notebook is being deleted.

FIG. 12 is a diagram illustrating an example display of page information for the third page of an electronic notebook.

FIG. 13 is a flowchart illustrating a flow of a page deleting process carried out by an electronic notebook function section of an electronic notebook device.

FIG. 14 is a functional block diagram illustrating an example configuration of an electronic notebook device of another embodiment of the present invention.

FIG. 15 illustrates an example user interface provided by an electronic notebook function of the electronic notebook device.

FIG. 16 illustrates an example user interface provided by the electronic notebook function of the electronic notebook device.

FIG. 17 illustrates an example user interface provided by the electronic notebook function of the electronic notebook device.

FIG. 18 illustrates another example user interface provided by the electronic notebook function of the electronic notebook device.

FIG. 19 illustrates another example user interface provided by the electronic notebook function of the electronic notebook device.

### DESCRIPTION OF EMBODIMENTS

### Embodiment 1

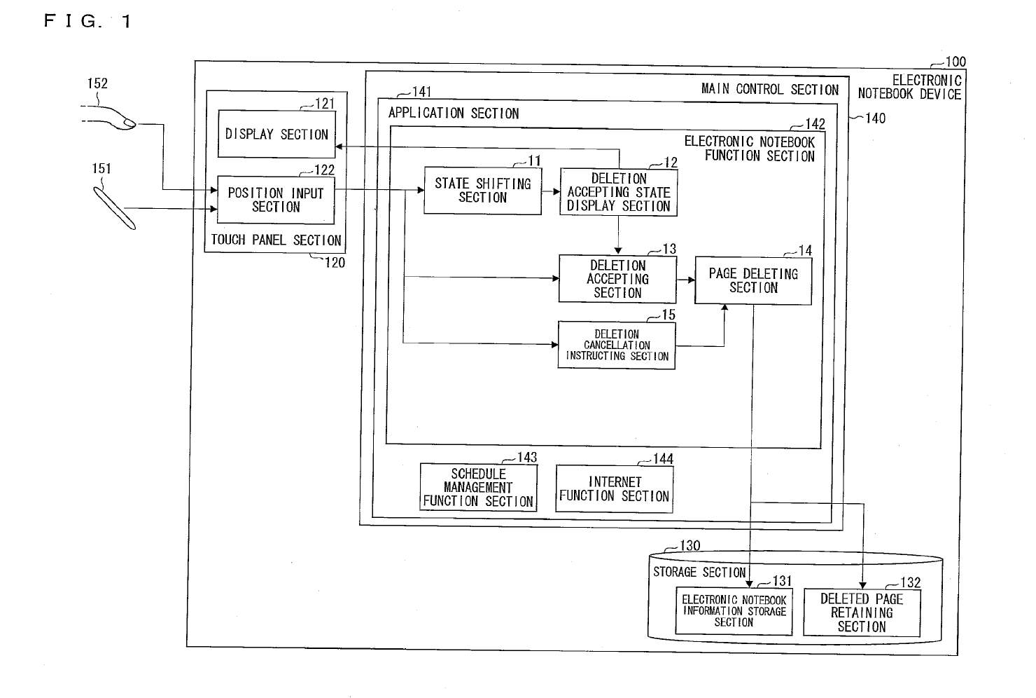

The description below deals with an embodiment of the present invention with reference to FIGS. 1 through 13.

The description below first outlines functions of an electronic notebook device (information processing device) 100 of the present embodiment with reference to FIG. 1. FIG. 1 is a block diagram illustrating an example configuration of the electronic notebook device 100.

The electronic notebook device 100 provides such information processing functions as a function of accepting a handwritten input from a user to allow the user to edit a notebook created on the basis of software. The description below uses the term “electronic notebook” to refer to such a notebook created on the basis of software.

The electronic notebook device 100, as illustrated in FIG. 1, includes a touch panel section 120, a storage section 130, and a main control section 140.

The touch panel section 120 provides such user interfaces as input operation and screen display of the electronic notebook device 100. The touch panel section 120 includes a display section 121 and a position input section (touch panel) 122.

The position input section 122 detects a touch position (that is, a position on an operation surface of the touch panel section 120 at which position a touching operation has been performed), and generates input position information corresponding to the position detected.

The term “touching operation” as used herein refers to an operation of bringing a pointing member such as a touch pen 151, the user's finger 152 or the like into contact with the operation surface. The term “touch position” as used herein refers more specifically to a position detected by the position input section 122 at which position the touch pen 151 or the user's finger 152 has been brought into contact with the operation surface.

The position input section 122 can be, for example, a touch panel. The position input section 122 of the present embodiment uses, by way of example, a capacitance method as a technique for detecting a touch position. The technique for detecting a touch position is, however, not limited to such a technique. The position input section 122 can, as appropriate, use any of various techniques such as matrix switch, resistor film method, surface acoustic wave method, infrared radiation method, electromagnetic induction method, capacitance method, and method (optical sensor method) for detecting an image of an object.

The position input section 122 is arranged, by way of example, to be capable of detecting a plurality of touch positions simultaneously. The position input section 122 is, however, not limited to such an arrangement, and may alternatively be arranged to detect only a single touch position.

The position input section 122, in detecting a touch position, discriminates between a touching operation performed with a touch pen 151 and a touching operation performed with the user's finger 152. This arrangement is achievable by, for example, arranging the position input section 122 as described below.

The position input section 122 detects the region of contact by a touch pen 151 or a finger 152, and calculates the size of the region detected. In the case where the calculated size of the region is larger than a predetermined size, the position input section 122 determines that a touching operation has been performed with a finger 152. In the case where the calculated size of the region is smaller than the predetermined size, the position input section 122 determines that a touching operation has been performed with a touch pen 151.

The position input section 122 may include, in the input position information, information on a category indicative of whether a touching operation has been performed with a touch pen 151 or with the user's finger 152.

The position input section 122 can detect a so-called hovering state of the pen nib of a touch pen 151, that is, a state in which the pen nib of a touch pen 151 is in no contact with the operation surface of the touch panel section 120, but is held at such a close position as to be separated from the operation surface by only a minute distance. In other words, the term “touching operation” may include causing the pen nib of a touch pen 151 to be hovering near the touch panel section 120.

The position input section 122 may generate, as the input position information, two-dimensional coordinate data indicative of a touch position on the operation surface. The position input section 122 may detect the pressure of a touching operation to include, in the input position information, information on the detected pressure.

The display section 121 includes a display screen for displaying an image represented by image data. The display section 121 receives image data from the main control section 140, and displays an image on the display screen on the basis of the image data received. The display section 121 can be, for example, an LCD (liquid crystal display), a PDP (plasma display panel), an EL (electroluminescence) display, or electronic paper.

The position input section 122 is, by way of example, superimposed over the display screen of the display section 121 for an integrated structure so that the display screen has coordinates in correspondence with coordinates of the operation surface. The storage section 130 may store information for correspondence between the coordinates of the display screen and those of the operation surface.

The position input section 122, in order not to block display on the display screen of the display section 121, has a portion corresponding to the display screen which portion is formed of a light-transmitting member.

The above arrangement allows the user to simultaneously (i) view a screen displayed in the display section 121 and (ii) perform an input operation on the operation surface. Such a screen displayed in the display section 121 is specifically exemplified as follows: The display section 121 displays GUIs (graphical user interfaces) such as an icon on its display screen. The user touching the operation surface of the position input section 122 with a finger (or a touch pen) causes the position input section 122 to generate coordinate information corresponding to an icon or image touched by the user.

The above description has dealt with an example arrangement of the touch panel section 120. The arrangement of the touch panel section 120 is, however, not limited to the above example. The touch panel section 120 may have any structure as long as such a structure allows a display screen and an operation surface to be used in combination with each other.

The storage section 130 stores various data and programs. The storage section 130 can be, for example, a hard disk, a flash memory, a ROM (read only memory), and/or a RAM (random access memory). The storage section 130 will be described later in detail.

The main control section 140 centrally controls various sections of the electronic notebook device 100. The main control section 140 has functions each performed by causing a CPU (central processing unit) to execute a program stored in a storage element such as a RAM or a flash memory.

(Detailed Arrangements of Storage Section and Main Control Section)

The description below deals in greater detail with respective arrangements of the storage section 130 and the main control section 140.

The description below first deals with the arrangement of the storage section 130. The storage section 130, as illustrated in FIG. 1, includes an electronic notebook information storage section 131 and a deleted page retaining section 132.

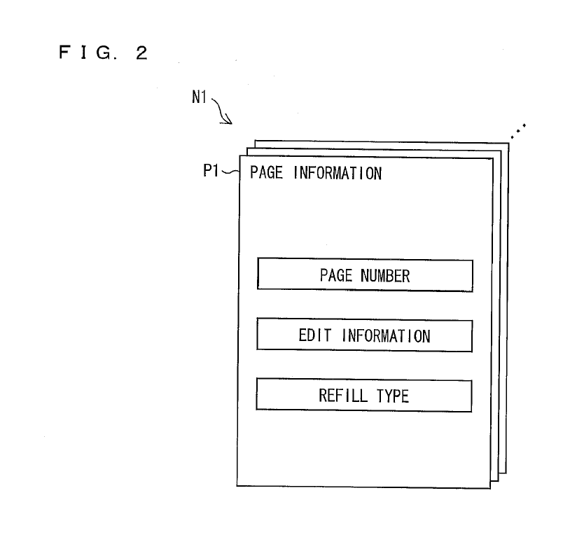

The electronic notebook information storage section 131 stores electronic notebook information. The description below deals with a data structure of electronic notebook information with reference to FIG. 2. FIG. 2 is a data structure diagram illustrating an example data structure of electronic notebook information.

As illustrated in FIG. 2, electronic notebook information N1 includes page information P1, that is, electronic information on an individual page of the electronic notebook. The page information P1 includes data on a “page number”, “edit information”, and a “refill type”.

The “page number” indicates a page number assigned to the page. The “edit information” is a data region that the user can freely edit by handwriting through the touch panel section 120. The “edit information” can have a data format based on a digital ink method or on a bitmap method.

The “refill type” sets a type of refill for the page. The term “type of refill” as used herein refers to a design for the sheet, and serves to display, for example, ruled lines as drawn in a paper notebook. Such a display is carried out by, for example, displaying a background image of ruled lines and/or the like in the background of a sheet.

The refill has a plurality of types, examples of which include (i) a refill of lateral ruled lines such as lateral ruled lines with a 7-mm pitch and dotted lateral ruled lines with a 6-mm pitch, (ii) a refill of grid lines with a 5-mm pitch, (iii) a blank refill, and (iv) a refill for meeting minutes.

The deleted page retaining section 132 temporarily saves deleted page information.

With reference to FIG. 1 again, the description below deals with the main control section 140. The main control section 140 includes an application section 141 for carrying out information processing functions of the electronic notebook device 100.

The application section 141 includes an electronic notebook function section 142, a schedule management function section 143, and an Internet function section 144.

The electronic notebook function section 142 provides an electronic notebook function for editing and viewing an electronic notebook. The schedule management function section 143 provides a schedule management function for editing and managing a schedule. The Internet function section 144 provides an Internet function for connecting to the Internet for communication through a communication section (not shown) for communicating with an external network.

The application section 141 of the electronic notebook device 100, as described above, provides various functions including not only an electronic notebook function but also a schedule management function, an Internet function and the like. Such various functions provided by the application section 141 may be included in the electronic notebook device 100 in advance, or may each be added to the electronic notebook device 100 by installation of an application. In the case where any of the above various functions has been achieved by installation of an application, such a function may be added or deleted by uninstallation of the application.

The application section 141 can, in the case where the touch panel section 120 has accepted an application switching operation from the user, switch between (i) the electronic notebook function of the electronic notebook function section 142, (ii) the schedule management function of the schedule management function section 143, and (iii) the Internet function of the Internet function section 144, in accordance with the switching operation accepted.

The electronic notebook device 100 may be arranged such that the electronic notebook function of the electronic notebook function section 142 is started when the electronic notebook device 100 is activated.

The application section 141 further has a function of recognizing, on the basis of input position information transmitted from the position input section 122 of the touch panel section 120, a touching operation or a gesture performed by the user on the touch panel section 120. The term “gesture” as used herein refers to a touching operation performed in a predetermined pattern, and is described below in detail.

The application section 141 recognizes such gestures as a single touch, a double touch, a drag, and a flick.

A single touch refers to a gesture of performing a touching operation of bringing a finger 152 or the like into contact with the touch panel section 120 at a position and immediately pulling the finger 152 or the like off the touch panel section 120.

A double touch refers to a gesture of performing the above single touch continuously twice on the touch panel section 120 within a predetermined, short time period.

A drag refers to a gesture of sliding a finger 152 or the like over the touch panel section 120 while keeping the finger 152 or the like in contact with the touch panel section 120.

A flick refers to a gesture of performing a touching operation of (i) sliding a finger 152 or the like over the touch panel section 120 while keeping the finger 152 or the like in contact with the touch panel section 120 and then (ii) pulling the finger 152 or the like, which is in contact with the touch panel section 120, off the touch panel section 120 within a predetermined, short time period after the slide. A flick, in other words, refers to an action similar to the action of softly flipping a surface of the touch panel section 120.

The application section 141, upon recognition of a gesture, generates gesture information indicative of the gesture recognized.

The gesture information refers to information indicative of a change in coordinates of the touch position of a touch on the screen by the user. A specific example of gesture information is information indicative of the amount of a change in coordinates of a touch position which change occurred when the user performed a drag downwardly from above in the vertical direction over the screen. The gesture information may alternatively be information indicative of what gesture the user performed and what direction the user performed the gesture in.

The application section 141 transmits gesture information generated to the electronic notebook function section 142, the schedule management function section 143, and the Internet function section 144.

(Outline of Electronic Notebook Function)

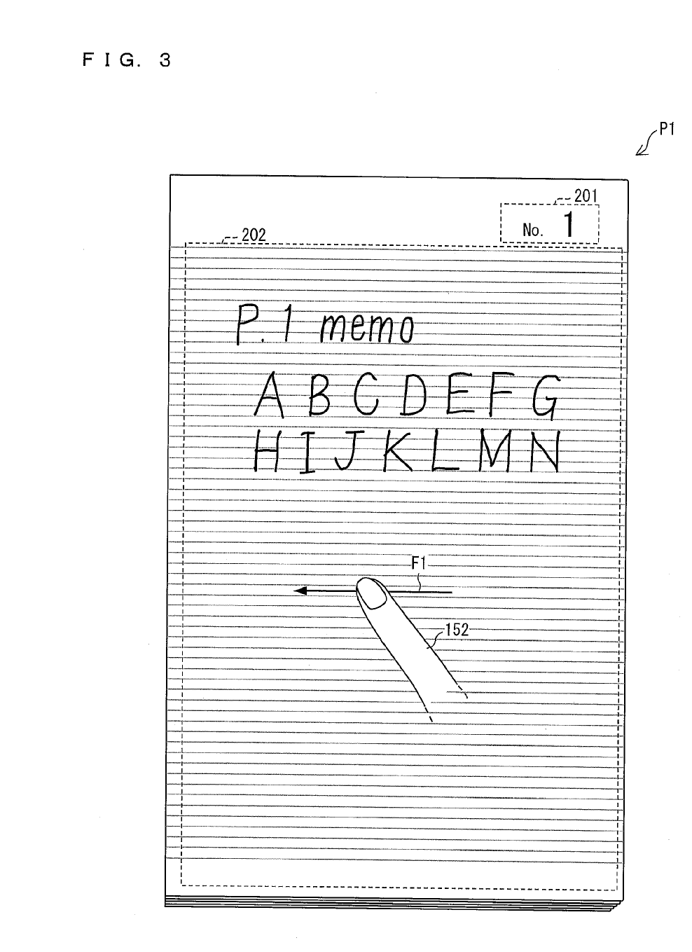

With reference to FIGS. 3 through 5, the description below outlines the electronic notebook function carried out by the electronic notebook function section 142 of the application section 141 included in the electronic notebook device 100.

With reference to FIG. 3, the description below first deals with an appearance of an electronic notebook displayed in the display section 121 of the touch panel section 120. FIG. 3 illustrates an example display of page information P1 for the first page of an electronic notebook.

This example page information P1 is so set as to have a “page number” of “1” and a “refill type” of “lateral ruled lines”. Further, the page information P1 has “edit information” of a handwritten input of “P1. memo ABCDEFGHIJKLMN”.

As illustrated in FIG. 3, the electronic notebook has a display region including (i) a page number region 201 for displaying a “page number” of the page information P1 and (ii) an edit region 202 for displaying “edit information”. The page number region 201 illustrated in FIG. 3 displays “1” (that is, the “page number” of the page information P1). The page number region 201 illustrated in FIG. 3 displays “P1. memo ABCDEFGHIJKLMN” (that is, the “edit information” of the page information P1).

The display of the page information P1 of FIG. 3 has, on the left side, a portion likened to the gutter of a paper notebook. In other words, the left side of FIG. 3 corresponds to a central portion of a two-page spread of a paper notebook, that is, the side of a notebook on which side the individual pages are bound. The display of the page information P1 of FIG. 3 has, on the right side, a portion corresponding to the outer edge of a paper notebook, that is, a portion likened to the fore edge of a paper notebook.

The above design is, however, described merely as an example. The page information P1 may alternatively be displayed as likened to a vertically openable notebook.

The user can edit the “edit information” in the edit region 202 through the touch panel section 120. The “page number” is managed by the electronic notebook function section 142 automatically allotting a number to a page.

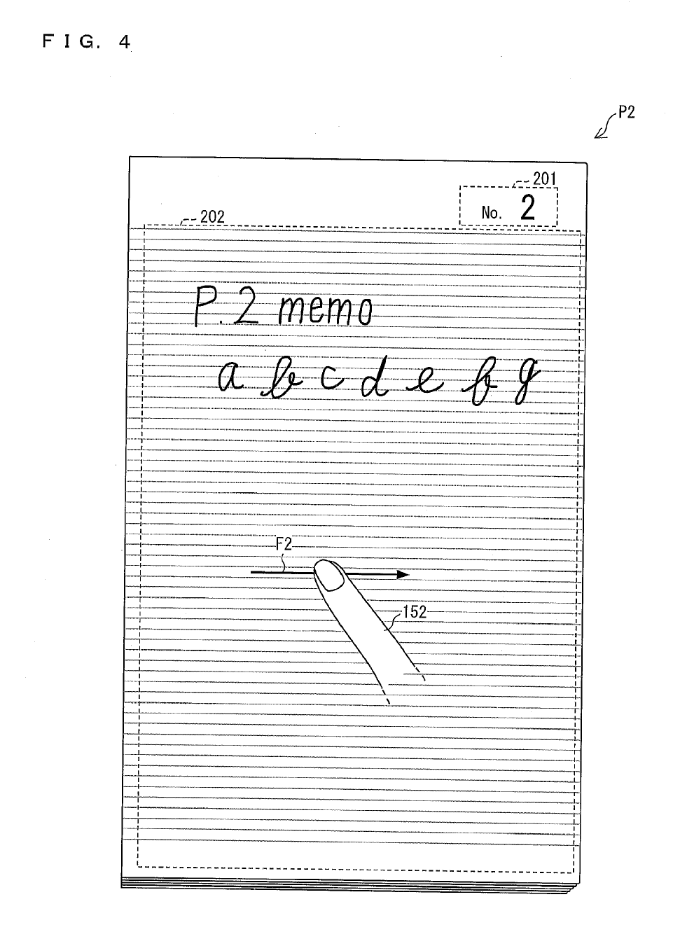

With reference to FIG. 4 in addition to FIG. 3, the description below deals with page shifting in an electronic notebook created by the electronic notebook function section 142. FIG. 4 illustrates an example display of page information P2 for the second page of the electronic notebook.

The electronic notebook function section 142 accepts page turning gesture information in either of the respective states illustrated in FIGS. 3 and 4. The page turning gesture information indicates, for example, a flick in a left-and-right direction that is parallel to the screen. The electronic notebook function section 142, in correspondence with the page turning gesture information, (i) reads, from the electronic notebook information storage section 131, page information for a page subsequent to the currently displayed page and causes the display section 121 to display the subsequent page, or (ii) reads, from the electronic notebook information storage section 131, page information for a page previous to the currently displayed page and causes the display section 121 to display the previous page.

Specifically, a flick (left flick) in the direction indicated by the arrow F1 in FIG. 3 first produces a display effect of the first page being turned, and then causes the electronic notebook function section 142 to read page information P2 for the second page. This in turn causes the display section 121 to display the page information P2 for the second page as illustrated in FIG. 4. In this example, the display section 121 displays “P.2 memo abcdefg” (edit information of the page information P2) as illustrated in FIG. 4.

Conversely, as illustrated in FIG. 4, a flick (right flick) in the direction of the arrow F2 in the state in which the page information P2 for the second page is displayed causes the electronic notebook function section 142 to read the page information P1 for the first page. This in turn causes the display section 121 to display the page information P1 for the first page illustrated in FIG. 3.

As described above, the electronic notebook function section 142 displays (i) a subsequent page upon detection of a left flick and (ii) a previous page upon detection of a right flick.

The electronic notebook function section 142 may be arranged to carry out no operation even upon detection of a right flick if the top page is being displayed, that is, the first page is being displayed. Further, the electronic notebook function section 142 may be arranged to create a new page and shift to that new page if the electronic notebook function section 142 has detected a left flick in the state in which the final page is being displayed.

The electronic notebook function section 142 may, in displaying page information, divide the display screen into two regions, and cause (i) one of the two display regions to display page information for a page and (ii) the other display region to display page information for another page.

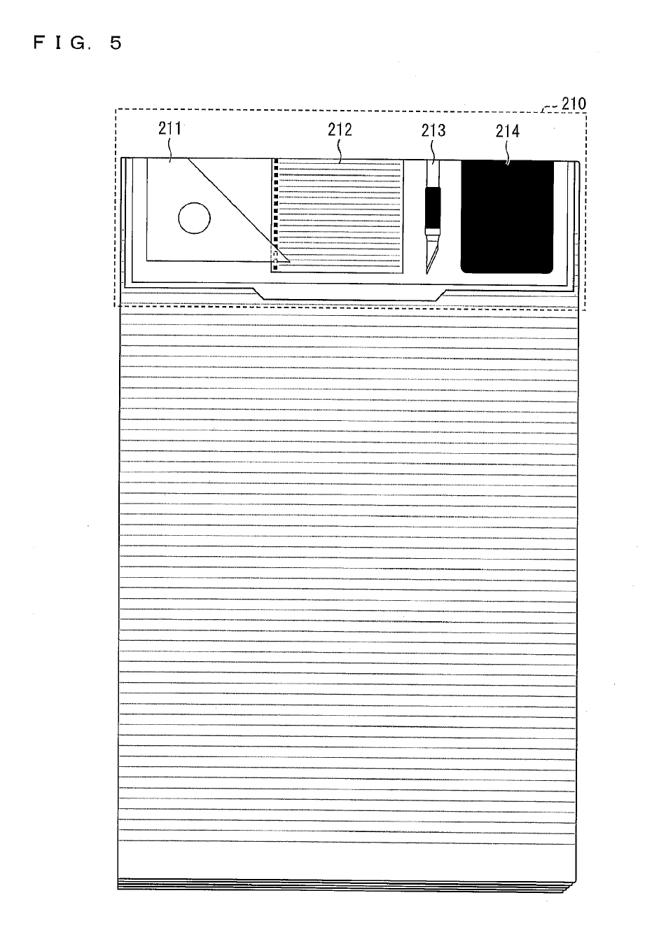

With reference to FIG. 5, the description below deals with an editing function carried out on an electronic notebook. The user can, in editing an electronic notebook, use a toolbox 210 as illustrated in FIG. 5 which toolbox 210 holds a collection of various editing functions. The toolbox 210 is invoked in response to the user's operation on the touch panel section 120, that is, gesture information transmitted from the application section 141.

The toolbox 210 stores tools (electronic stationery) that are used in the application in use.

The toolbox 210 illustrated in FIG. 5 stores, as examples, a ruler 211, a refill 212, an art knife 213, and a pencil case 214.

The ruler 211 is a tool for drawing a straight line or a figure such as a circle in the edit region 202.

The refill 212 is a tool for adding or deleting a page. In the case where a page is to be added with use of the refill 212, the user is prompted to select a refill type for the page to be added.

The art knife 213 is a tool for carrying out a function of cutting manually inputted edit information in the edit region 202, and is a tool for carrying out a so-called cut-and-paste function. In the case where a cut-and-paste operation is to be carried out with use of the art knife 213, the user first encircles a region targeted for cutout, and cuts off the target region. The user then drags the cutout region to another position on the same page or moves the cutout region to another page to paste the cutout region to a desired position.

The pencil case 214 is a main tool for editing an electronic notebook, and is a tool for manual input. The user can choose, from the pencil case 214, a pen of a desired type (for example, the user can select thickness of a line drawn with the pen and color for ink of the pen) for input.

The electronic notebook function section 142 may be arranged such that when the electronic notebook function is activated through a function switching operation, a pen tool contained in the pencil case 214 has been selected by default. The pencil case 214 further contains an eraser tool for erasing edit information inputted by handwriting.

(Page Deleting Function)

The above description has mentioned, with reference to FIG. 5, the function of deleting a page from an electronic notebook with use of the refill 212 in the toolbox 210. The electronic notebook function section 142 further provides a user interface described below for the function of deleting a page from an electronic notebook.

With reference to FIG. 1 again, the description below deals with a user interface for the page deleting function which user interface the electronic notebook function section 142 provides. The electronic notebook function section 142 includes a state shifting section (input operation detecting means) 11, a deletion accepting state display section (accepting state display means) 12, a deletion accepting section (page processing means) 13, a page deleting section (page processing means, deletion displaying means, state recovering means) 14, and a deletion cancellation instructing section (deletion canceling means) 15.

The state shifting section 11 shifts the electronic notebook function section 142 to a deletion mode (that is, a state of accepting deletion of the currently displayed page) upon receipt of gesture information from the application section 141 which gesture information is deletion mode shift gesture information for an instruction to shift to the deletion mode.

The deletion accepting state display section 12, in the case where the state shifting section 11 has shifted the electronic notebook function section 142 to the deletion mode, causes the display section 121 to display a screen indicative of the deletion mode.

The deletion accepting section 13, in the deletion mode, accepts deletion gesture information indicative of a gesture for an instruction of page deletion. Specifically, the deletion accepting section 13 determines whether gesture information transmitted from the application section 141 serves as an instruction of page deletion. In the case where the gesture information is deletion gesture information for an instruction of page deletion, the deletion accepting section 13 instructs the page deleting section 14 to delete the currently displayed page. The page deleting section 14, in accordance with an instruction from the deletion accepting section 13, causes the display section 121 to display a display effect of page deletion, and deletes the currently displayed page. The above display effect will be described later in detail.

The page deleting section 14 can, while causing the display section 121 to display the display effect of page deletion, also accept an instruction to cancel the page deletion. The page deleting section 14, upon acceptance of an instruction to cancel page deletion, cancels deletion of a page that the page deleting section 14 is currently deleting.

The electronic notebook function section 142 may be arranged such that page information on a page deleted by the page deleting section 14 is saved in the deleted page retaining section 132, and may further be arranged such that such page information on a deleted page can be recovered or completely erased from the deleted page retaining section 132 at any timing.

The arrangement of the electronic notebook function section 142 is, however, not limited to the above. Alternatively, the page adding section 17 may completely delete page information on a deleted page from the electronic notebook information storage section 131 immediately.

Further, the page deleting section 14, in deleting a page, appropriately updates respective page numbers assigned to (i) the page subsequent to the deleted page and (ii) pages later than the subsequent page. The page deleting section 14, for example, decreases each of the above respective page numbers by 1.

The deletion cancellation instructing section 15, in the case where it has received, while the page deleting section 14 is causing the display section 121 to display the display effect of page deletion, cancellation gesture information from the application section 141 which cancellation gesture information indicates a gesture for an instruction of cancellation of page deletion, transmits to the page deleting section 14 an instruction to cancel the deletion of the page currently being deleted.

(Operation Carried Out with Page Deleting Function in Detail)

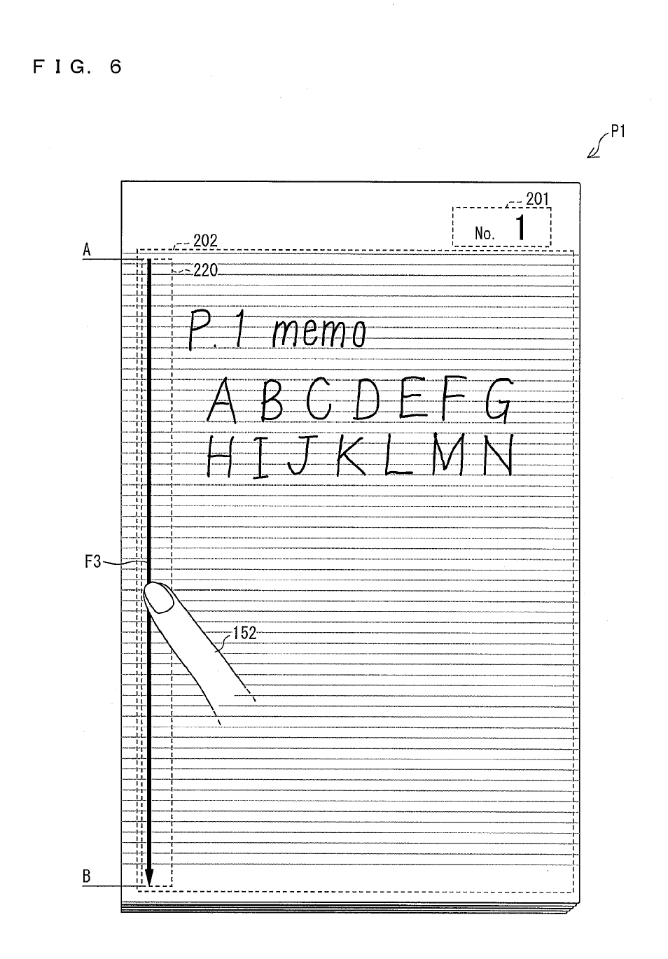

With reference to FIGS. 6 through 11, the description below deals in detail with an operation carried out with use of the function of deleting a page from an electronic notebook which function the electronic notebook function section 142 has.

First, in the state in which the page information P1 for the first page is displayed as illustrated in FIG. 3, the state shifting section 11 accepts deletion mode shift gesture information.

The deletion mode shift gesture information refers to gesture information indicative of a gesture exemplified in FIG. 6. Specifically, the deletion mode shift gesture information refers to gesture information indicative of a gesture of a drag performed, as illustrated in FIG. 6, by the user with use of a finger 152 or the like along the vertical direction of the arrow F3 from the point A to the point B in a region 220 located along the left edge of the screen. The deletion mode shift gesture information is, however, not limited to the above, and may alternatively indicate a drag or flick performed in the region 220 along the direction of the arrow F3.

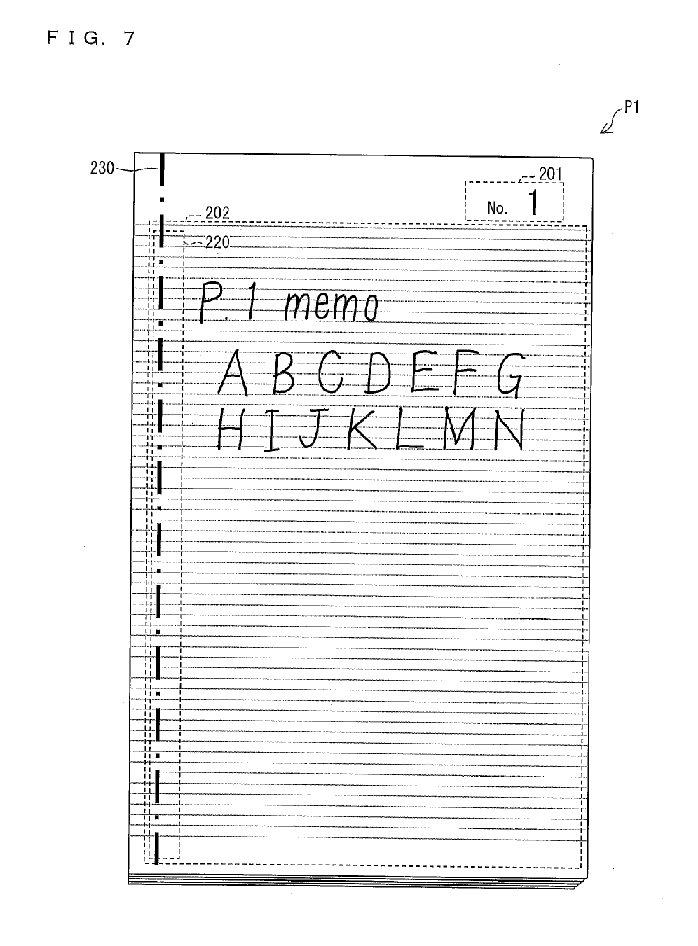

In the case where the state shifting section 11 has accepted deletion mode shift gesture information indicative of a gesture as exemplified in FIG. 6, the deletion accepting state display section 12 causes the display section 121 to display, as illustrated in FIG. 7, a screen indicating that the electronic notebook function section 142 is in the deletion mode.

Specifically, the deletion accepting state display section 12 causes the display section 121 to display, as illustrated in FIG. 7, a cutoff line 230 in the region 220 located along the left edge of the screen.

FIG. 7 illustrates a dotted-and-dashed line as an example of the cutoff line 230. The cutoff line 230 is, however, not limited to a dotted-and-dashed line, and is not particularly limited in form. The cutoff line 230 may be, for example, a broken line or a wavy line. The deletion accepting state display section 12 may cause the display section 121 to display not only a cutoff line 230 but also, for example, a message or icon indicative of the deletion mode.

In the case where a cutoff line as illustrated in FIG. 7 is being displayed in the region 220 in the deletion mode, the deletion accepting section 13 accepts deletion gesture information.

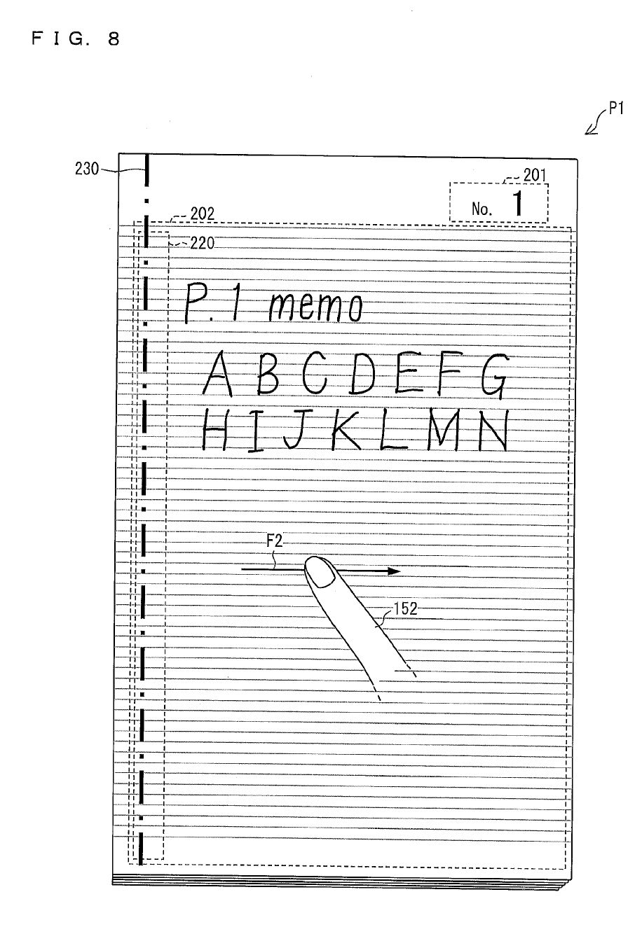

Specifically, the deletion gesture information refers to gesture information indicative of a gesture of the user sliding a finger 152 or the like along the direction of the arrow F2 as illustrated in FIG. 8. More specifically, the user can delete the currently displayed page by sliding a finger 152 or the like from left to right along the direction parallel to the screen, that is, a direction substantially perpendicular to the side of the notebook on which side the individual pages are bound.

The above gesture indicated by deletion gesture information imitates the action of tearing a page off a paper notebook. In other words, the deletion gesture imitates the action of pulling a page of a paper notebook in a direction away from the side of the paper notebook on which side the individual pages are bound and thus tearing the page off the paper notebook.

Stated further differently, the deletion gesture imitates the action of pulling a page of a paper notebook in a direction extending from the gutter at the center of a two-page spread to the outer edge, that is, the fore edge, of the paper notebook and thus tearing the page off the paper notebook.

The gesture indicated by deletion gesture information, as described above, imitates the action of tearing a page off a paper notebook. This allows the user to intuitively perform an operation of deleting a page from an electronic notebook in the electronic notebook device 100.

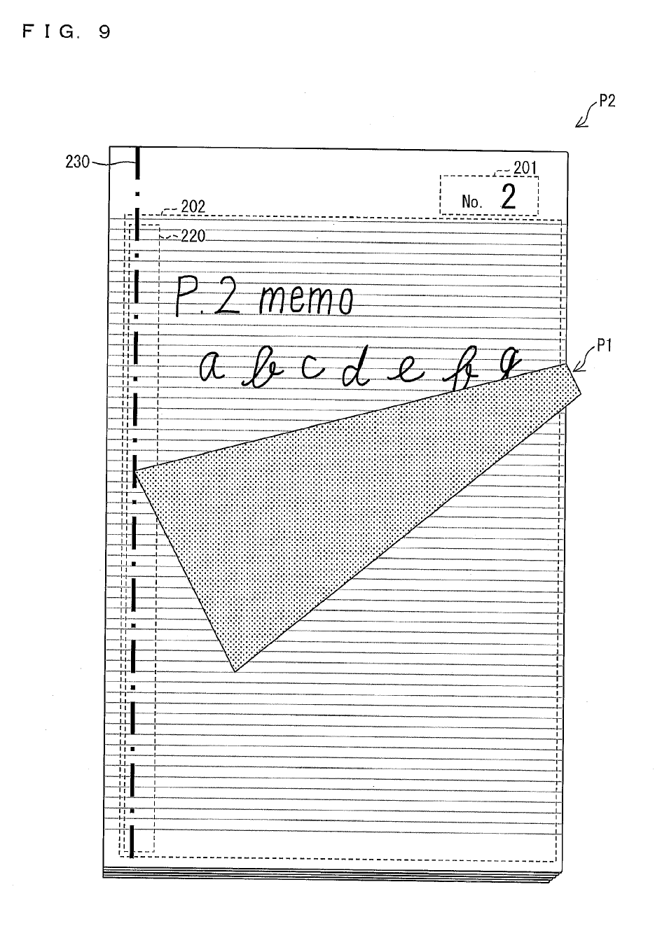

In the case where the deletion accepting section 13 has received deletion gesture information, the page deleting section 14 causes the display section 121 to display a display effect of page deletion as exemplified in FIG. 9.

Specifically, the page deleting section 14 causes the display section 121 to display, as exemplified in FIG. 9, a display effect of the first page (page information P1) being torn downwardly from above along the cutoff line 230 and turned over. The page deleting section 14 further causes the display section 121 to display, as illustrated in FIG. 9, a portion of page information P1 for the second page as a result of the first page being turned over.

In the case where the deletion cancellation instructing section 15 has received cancellation gesture information while the above display effect is being displayed, the page deleting section 14 cancels its page deleting process.

An example of the cancellation gesture is a gesture of sliding a finger 152 or the like along the direction opposite to the direction for the deletion gesture, that is, along the direction opposite to the direction indicated by the arrow F2. This arrangement, which involves a gesture reverse to the cancellation gesture, allows the user to intuitively perform an operation of canceling page deletion.

Another example of the cancellation gesture is a gesture of sliding a finger 152 along the direction opposite to the downward direction in which the page is being torn along the cutoff line 230 and turned over, that is, sliding a finger 152 upwardly from below over the screen. This arrangement allows the user to cancel page deletion as if by blocking the display effect, that is, as if by preventing the page from being turned over.

Still another example of the cancellation gesture is a simple touching operation on the touch panel section 120. In this arrangement, the deletion cancellation instructing section 15 may, in the case where the above simple touching operation has continued for a predetermined time period, instruct the page deleting section 14 to cancel the page deleting process. The deletion cancellation instructing section 15 may, depending on the strength (for example, a sliding distance and acceleration) of the deletion gesture, vary the time period of a continued touching operation which time period is necessary to cancel a page deleting process.

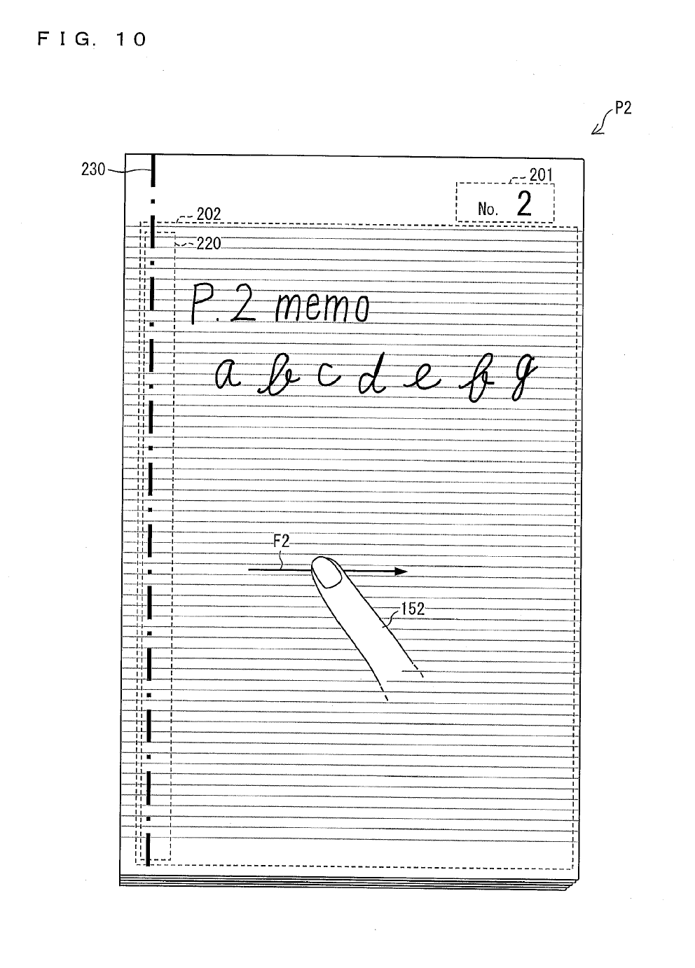

When the page torn off has been turned over in its entirety and moved out of the screen, this display effect ends, which results in the display section 121 displaying the page information P2 for the second page in its entirety as illustrated in FIG. 10. The page deleting section 14 may, at this stage, cause the display section 121 to display a recycle bin icon over the currently displayed second page to indicate that the deleted page information is saved in the deleted page retaining section 132. Further, the page deleting section 14 may, in the case where the user has performed a touching operation on the recycle bin icon, (i) prompt the user to choose, from among deleted page information items, a page information item(s) to be recovered, and (ii) recover the page information item(s) chosen by the user.

The page deleting section 14, when the display of the above display effect has ended, deletes the page information P1 for the first page from the electronic notebook information storage section 131.

The state illustrated in FIG. 10 indicates that the electronic notebook function section 142 is still in the deletion mode. The page deleting section 14 can, in this state, accept further deletion gesture.

Specifically, in the case where the deletion accepting section 13 has accepted deletion gesture information indicative of a gesture of sliding a finger 152 or the like along the direction indicated by the arrow F2, the page deleting section 14 carries out a process of deleting the page information P2 for the second page.

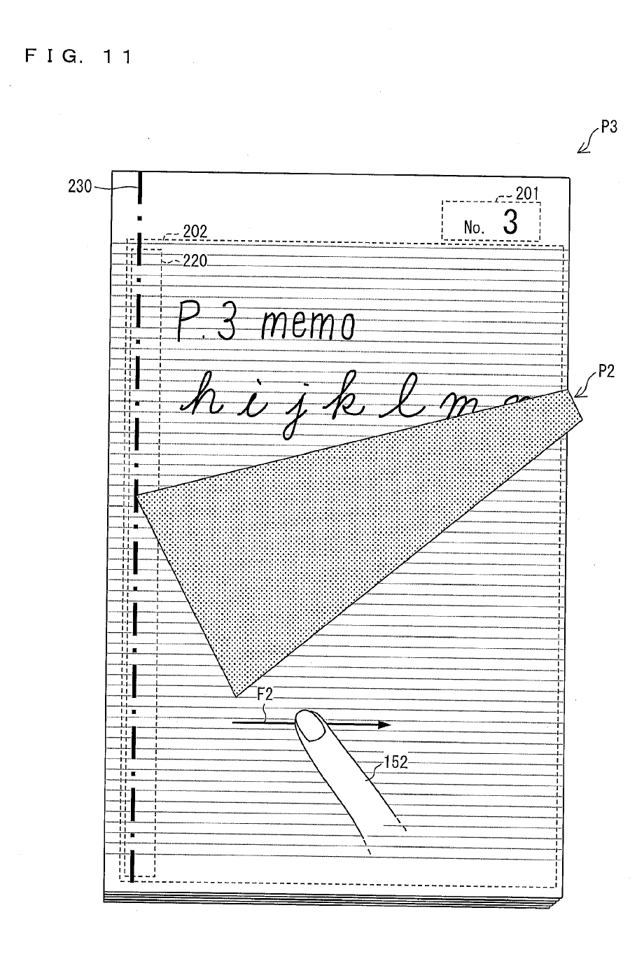

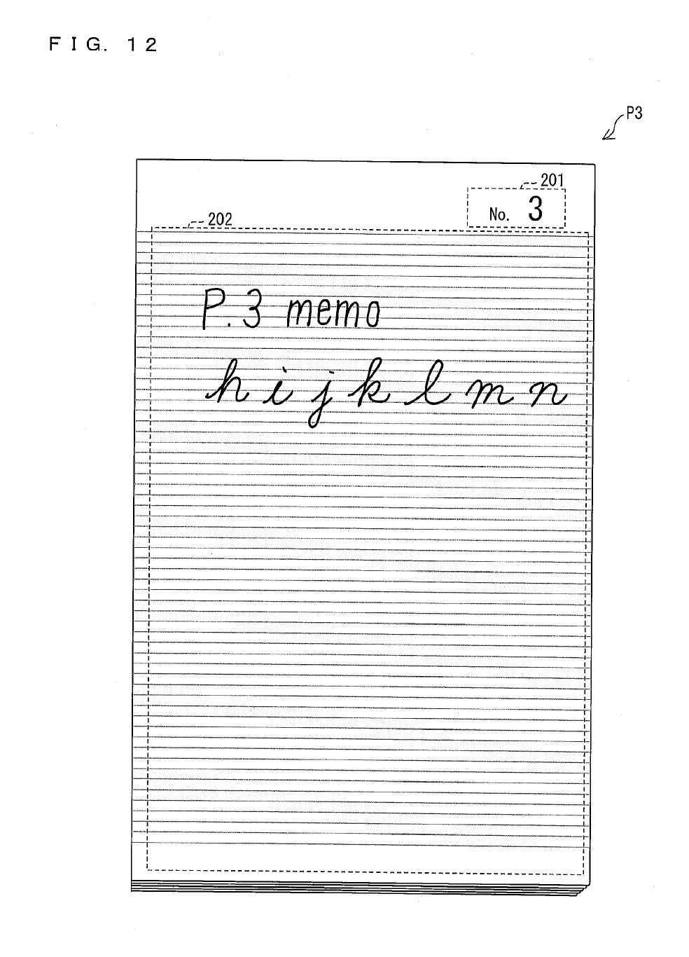

More specifically, the page deleting section 14 tears the second page (page information P2) off along the cutoff line 230 as illustrated in FIG. 11. The page information P2 for the second page is thus deleted, which causes the display section 121 to display page information P3 for the third page as illustrated in FIG. 12.

The page information P3 includes a handwritten input of edit information of “P.3 memo hijklmn”, and displays that edit information in the edit region 202.

As described above, in the deletion mode, the deletion accepting section 13 constantly accepts deletion gesture information, and the page deleting section 14, in response to such deletion gesture information, carries out a process of deleting page information being displayed at that time.

The electronic notebook function section 142, in the case where it has received no gesture information for a predetermined time period after shifting to the deletion mode, erases the cutoff line 230 from the screen and escapes from the deletion mode as illustrated in FIG. 12.

(Flow of Process Carried Out by Electronic Notebook Function Section)

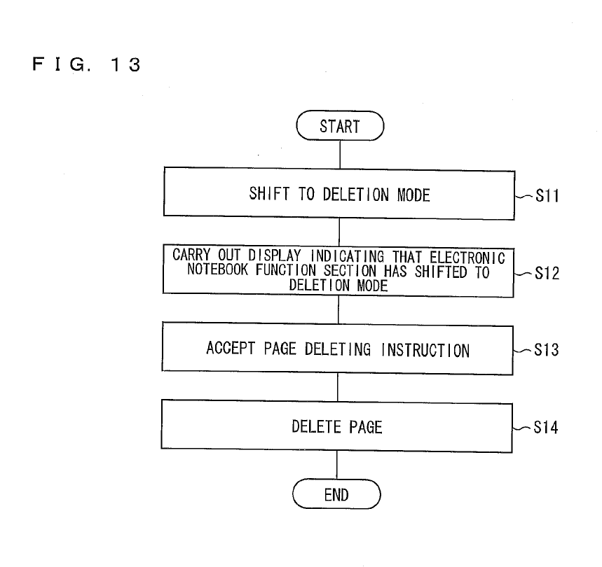

With reference to FIG. 13, the description below deals with a flow of a process carried out by the electronic notebook function section 142. FIG. 13 is a flowchart illustrating a flow of a page deleting process carried out by the electronic notebook function section 142 of the electronic notebook device 100.

First, when the state shifting section 11 has received deletion mode shift gesture information, the electronic notebook function section 142 shifts to the deletion mode (S11). Then, the deletion accepting section 13 causes the display section 121 to display a screen indicating that the electronic notebook function section 142 has shifted to the deletion mode (S12).

Next, when the deletion accepting section 13 has received deletion gesture information (S13), the page deleting section 14 causes the display section 121 to display a display effect of page deletion, and deletes page information for the currently displayed page from the electronic notebook information storage section 131 (S14).

(Operation and Effect)

As described above, the electronic notebook device 100 of the present embodiment is an electronic notebook device 100 for, in response to an input operation performed with respect to a touch panel section 120 including a display section 121 and a position input section 122, displaying page information as a page in the display section 121, the electronic notebook device 100 including: a state shifting section 11 for accepting deletion mode shift gesture information indicative of a gesture performed in a direction along, among the sides of a page displayed, a side on which the page is bound; and a page deleting section 14 for deleting page information for the currently display page in the case where a deletion accepting section 13 has accepted gesture information indicative of a gesture performed in a direction away from the page binding side after the state shifting section 11 has accepted the deletion mode shift gesture information.

The above arrangement can provide a user interface that allows the user to delete a page through an intuitive operation similar to the action of actually removing a page from a paper notebook or book.

### Embodiment 2

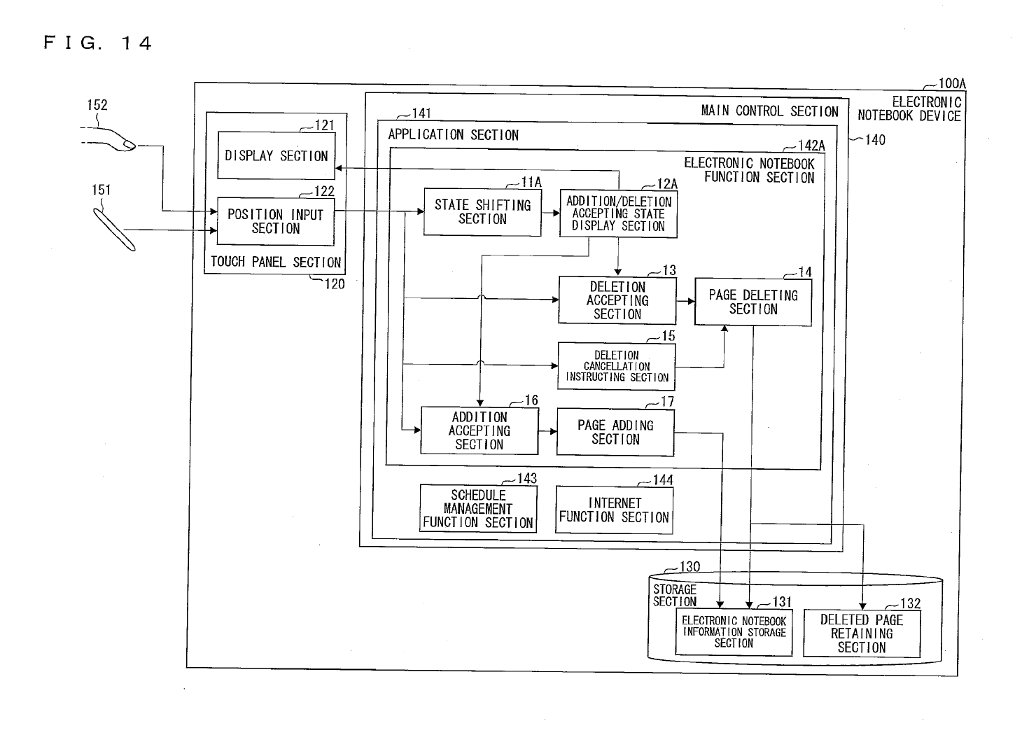

The description below deals with another embodiment of the present invention with reference to FIGS. 14 through 17. The present embodiment describes a case involving a user interface in a so-called loose-leaf form for an electronic notebook. For convenience of explanation, members of the present embodiment that are identical in function to respective corresponding members described in Embodiment 1 above with reference to drawings are each assigned a common reference numeral, and are not described here.

The description below first deals with another example configuration of an electronic notebook device (information processing device) 100A of the present embodiment with reference to FIG. 14. FIG. 14 is a functional block diagram illustrating another example configuration of the electronic notebook device 100A.

The electronic notebook device 100A is, as illustrated in FIG. 14, identical to the electronic notebook device 100 of FIG. 1 except that the electronic notebook function section 142 of the electronic notebook device 100 is replaced by an electronic notebook function section 142A.

The electronic notebook function section 142A differs from the electronic notebook function section 142 of FIG. 1 in that (i) the state shifting section 11 and the deletion accepting state display section 12 are replaced by a state shifting section 11A and an addition/deletion accepting state display section 12A, respectively, and that (ii) the electronic notebook function section 142A further includes an addition accepting section (page processing means) 16 and a page adding section (page processing means) 17.

The description below deals with the above members of the electronic notebook function section 142A that are not included in the electronic notebook function section 142 of FIG. 1.

The state shifting section 11A shifts the electronic notebook function section 142 to an addition/deletion mode (that is, a state of accepting page addition or deletion of the currently displayed page) upon receipt of gesture information from the application section 141 which gesture information is addition/deletion mode shift gesture information for an instruction to shift to the addition/deletion mode.

The addition/deletion accepting state display section 12A, in the case where the state shifting section 11A has shifted the electronic notebook function section 142 to the addition/deletion mode, causes the display section 121 to display a screen indicative of the addition/deletion mode.

The addition accepting section 16, in the addition/deletion mode, accepts addition gesture information indicative of a gesture for an instruction of page addition. Specifically, the addition accepting section 16 determines whether gesture information transmitted from the application section 141 serves as an instruction of page addition. In the case where the gesture information is addition gesture information for an instruction of page addition, the addition accepting section 16 instructs the page adding section 17 to add a new page.

The page adding section 17, in accordance with an instruction from the addition accepting section 16, causes the display section 121 to display a display effect of page addition, and adds a new page.

The page adding section 17 may add a new page either in front or in back of the currently displayed page. There is no particular limit to the position to which to insert a new page. The page adding section 17, in the case where it has added a new page, stores page information for that new page in the electronic notebook information storage section 131.

The page adding section 17, in adding a page, appropriately updates respective page numbers assigned to (i) the page subsequent to the added page and (ii) pages later than the subsequent page. The page adding section 17, for example, increases each of the above respective page numbers by 1.

(Operation in Addition/Deletion Mode in Detail)

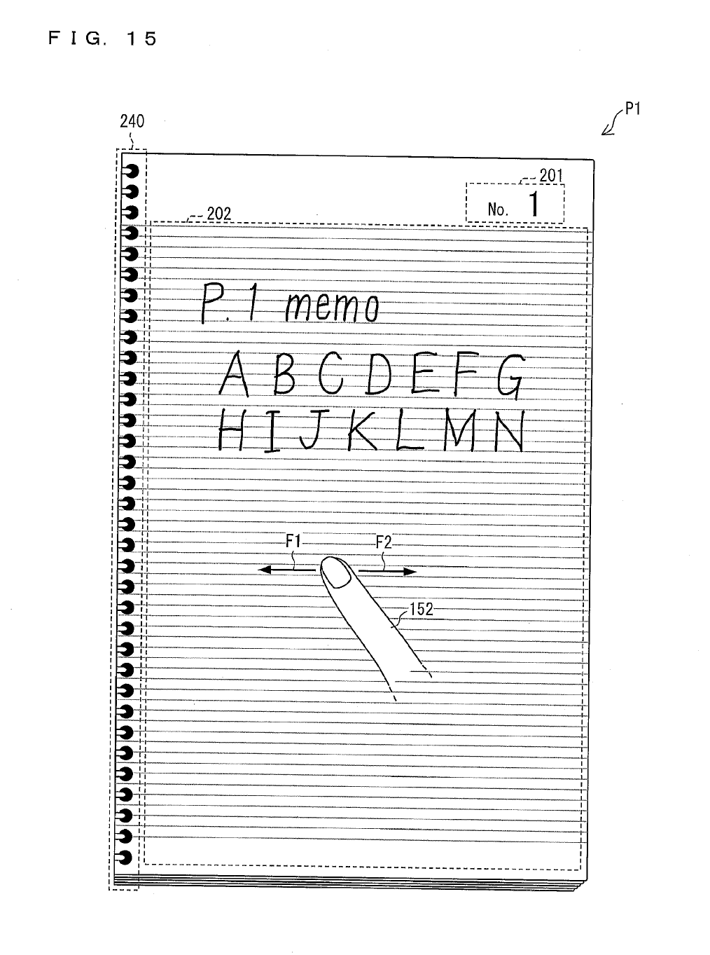

With reference to FIGS. 15 through 17, the description below deals in detail with an operation carried out with use of a page addition/deletion function of the electronic notebook function section 142A.

FIG. 15 illustrates a user interface that the electronic notebook function section 142A provides. Specifically, FIG. 15 illustrates a state in which page information P1 for the first page is being displayed in the display section 121.

The user interface illustrated in FIG. 15 differs from that of FIG. 3 in that (i) the user interface illustrated in FIG. 15 includes a ring display region 240 along the left edge of the screen instead of the region 220 and that (ii) the ring display region 240 displays an image of rings for holding loose leaves.

The ring display region 240 displays an image of closed loose-leaf rings. This imitates loose leaves bound with rings in a loose-leaf notebook as an actual stationery tool.

The electronic notebook function section 142A accepts page turning gesture information in the state illustrated in FIG. 15. Specifically, the electronic notebook function section 142A, in the state illustrated in FIG. 15, displays (i) a subsequent page upon detection of a left flick and (ii) a previous page upon detection of a right flick.

In the state in which the page information P1 for the first page as illustrated in FIG. 15 is being displayed, the state shifting section 11A accepts addition/deletion mode shift gesture information.

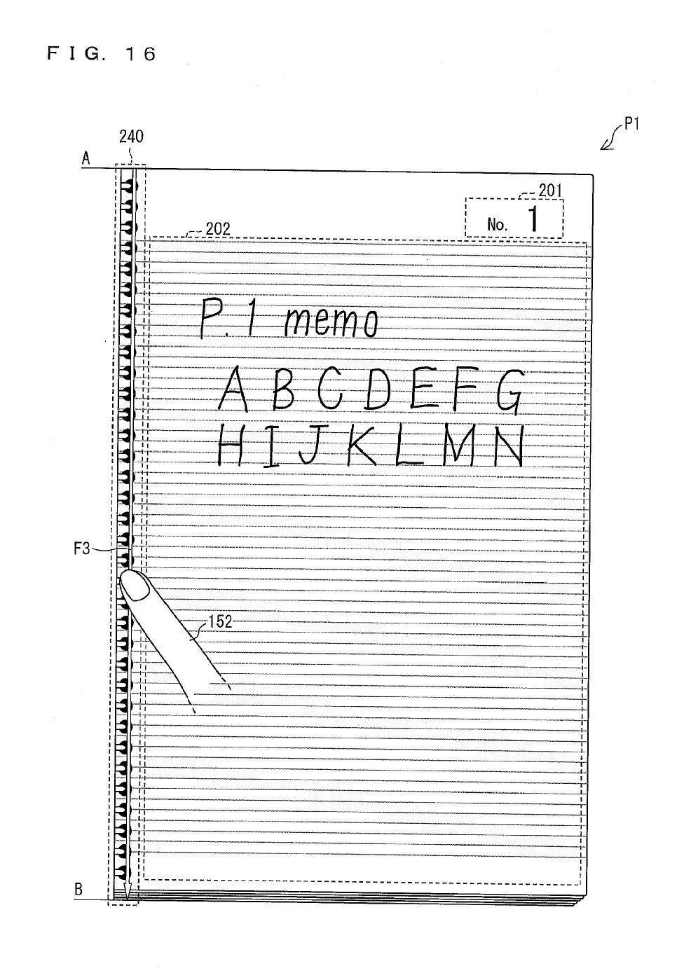

The addition/deletion mode shift gesture information refers to gesture information indicative of a gesture exemplified in FIG. 16. Specifically, the addition/deletion mode shift gesture information refers to gesture information indicative of a gesture of a drag performed, as illustrated in FIG. 16, by the user with use of a finger 152 or the like along the vertical direction of the arrow F3 from the point A to the point 13 in the ring display region 240 located along the left edge of the screen. The addition/deletion mode shift gesture information is, however, not limited to the above, and may alternatively indicate a drag or flick performed in the ring display region 240 along the direction of the arrow F3.

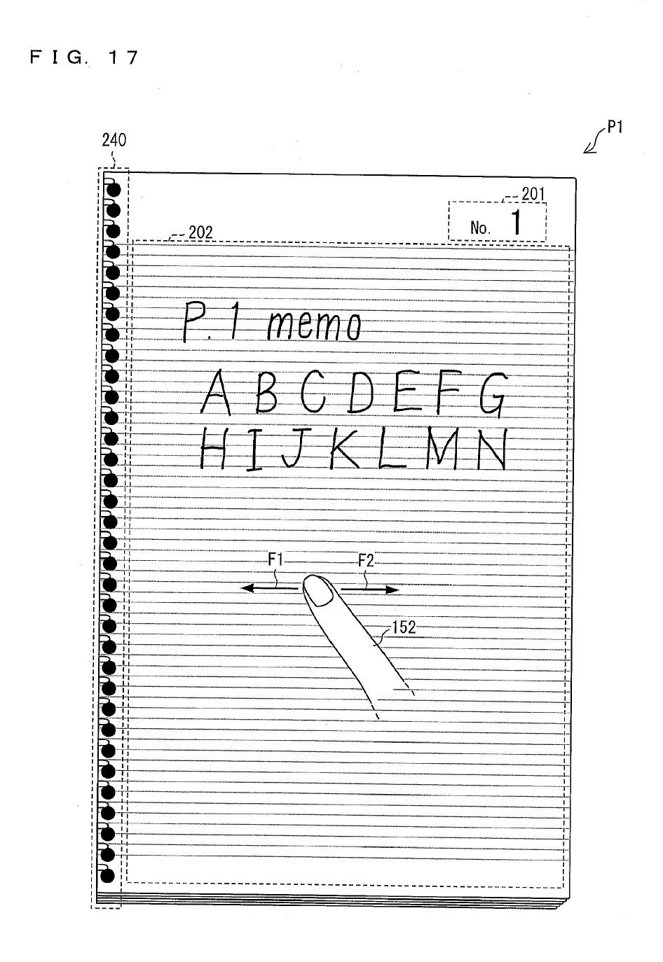

In the case where the state shifting section 11A has accepted addition/deletion mode shift gesture information indicative of a gesture as exemplified in FIG. 16, the addition/deletion accepting state display section 12A causes the display section 121 to display, as illustrated in FIG. 17, a screen indicating that the electronic notebook function section 142A is in the addition/deletion mode.

Specifically, the addition/deletion accepting state display section 12A causes the display section 121 to display, as illustrated in FIG. 17, an image of open loose-leaf rings in the ring display region 240 located along the left edge of the screen.

In a loose-leaf notebook as an actual stationery tool, a refill may be inserted or removed in the state in which the rings binding the individual loose leaves are open. The image displayed in the ring display region 240 of FIG. 17 imitates the above state.

In the addition/deletion mode, the deletion accepting section 13 accepts deletion gesture information, whereas the addition accepting section 16 accepts addition gesture information.

The deletion gesture information that the deletion accepting section 13 accepts has already been described above with reference to, for example, FIG. 8, and is thus not described here.

The addition gesture information that the addition accepting section 16 accepts is described below. The addition gesture information refers to gesture information indicative of a gesture of the user sliding a finger 152 or the like along the direction of the arrow F1 as illustrated in FIG. 17. More specifically, the user can add a new page by sliding a finger 152 or the like from right to left along the direction parallel to the screen, that is, a direction substantially perpendicular to the side of the notebook on which side the individual pages are bound.

A new page to be added may be inserted either in front or in back of the currently displayed page.

The above gesture indicated by addition gesture information imitates the action of inserting a loose leaf in a loose-leaf notebook as an actual stationery tool with use of rings.

The electronic notebook function section 142A, in the case where it has received no gesture information for a predetermined time period after shifting to the addition/deletion mode, escapes from the addition/deletion mode.

The gesture indicated by addition gesture information, as described above, imitates the action of adding a loose leaf in a loose-leaf notebook as an actual stationery tool. This allows the user to intuitively perform an operation of adding a refill in the electronic notebook device 100.

As described above, the electronic notebook device 100A accepts page addition or page deletion by, while displaying electronic information to be presented as a page, detecting an input operation performed in the vicinity of the side along which individual pages are bound. Further, the electronic notebook device 100A adds a page by accepting addition gesture information, and deletes a page by accepting deletion gesture information.

The above arrangements allow the electronic notebook device 100A to provide a user interface that is convenient for the user in performing a process of adding or deleting a page.

(Variation)

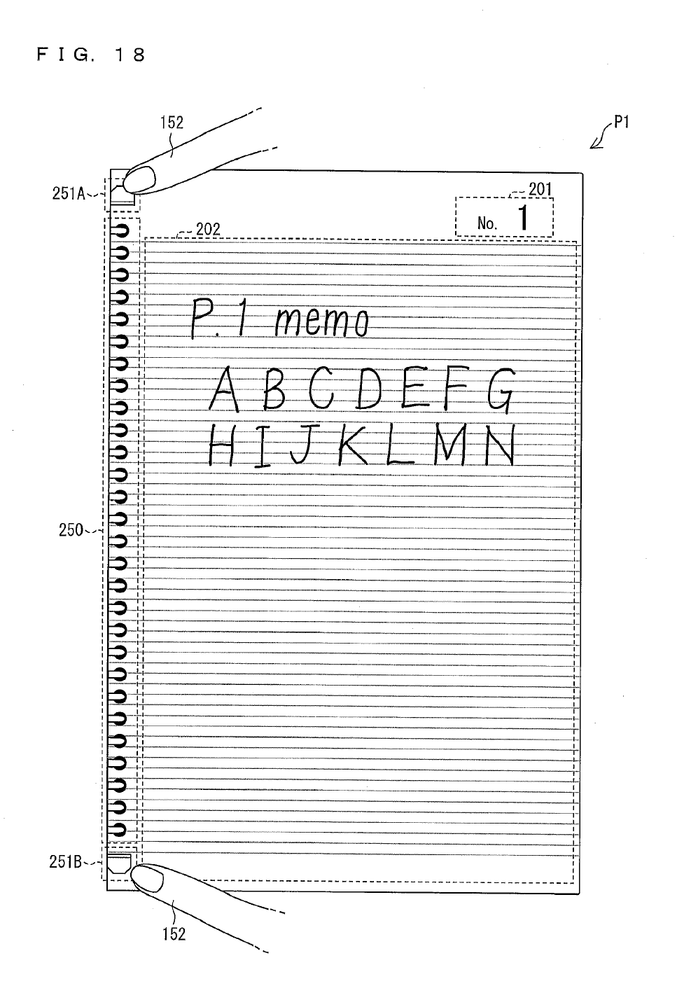

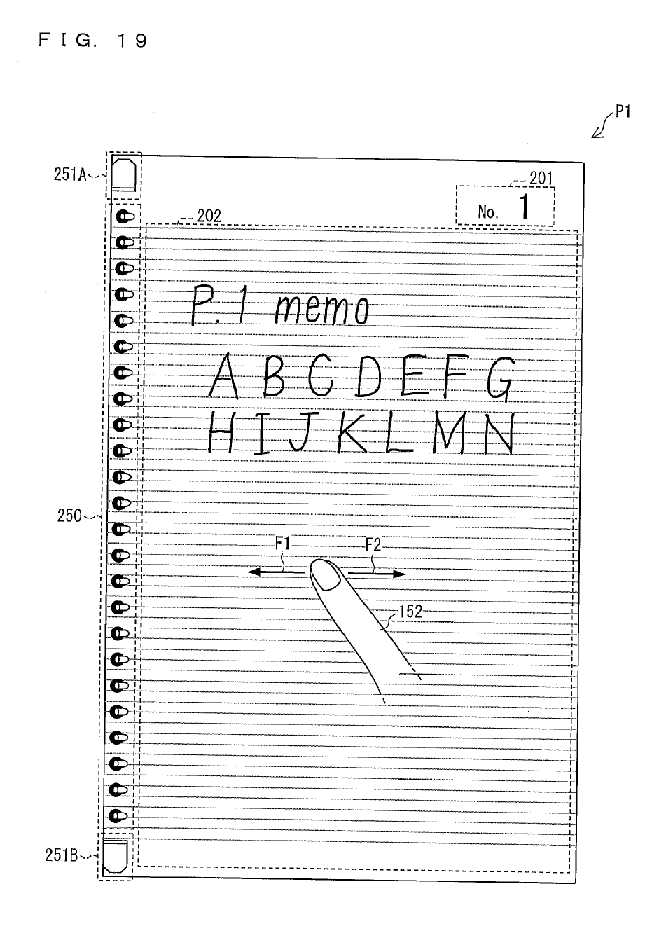

The description below deals with a preferable variation of the electronic notebook device 100A with reference to FIGS. 18 and 19. In the variation described below, the electronic notebook function section 142A displays levers for loose-leaf rings, and accepts an input operation performed on the levers.

As illustrated in FIG. 18, the electronic notebook function section 142A displays, on a left portion of the screen, (i) an image of levers for loose-leaf rings in respective lever display regions 251A and 251B and (ii) an image of loose-leaf rings in a ring display region 250.

More specifically, the lever display regions 251A and 251B are provided near the respective ends of the ring display region 250, that is, respectively at the upper left corner and lower left corner of the screen, in a manner similar to the manner in which levers for rings included in an actual loose-leaf notebook are provided near the respective ends of a line of the rings.

In an actual loose-leaf notebook, performing an operation of pressing down levers for the rings opens the rings, whereas performing an operation of pulling up levers for the rings closes the rings. The image of the levers that the electronic notebook function section 142A displays in the respective lever display regions 251A and 251B imitates an appearance of such a loose-leaf notebook.

FIG. 18 illustrates a state in which the loose-leaf rings are closed. In this state, the electronic notebook function section 142A accepts page turning gesture information, and carries out a page shifting operation upon such acceptance. This page shifting operation is as described above, and is thus not described here.

The state shifting section 11A, in the above state, accepts lever operating gesture information. The lever operating gesture information refers to gesture information indicative of a gesture of the user performing a touching operation in the lever display regions 251A and 251B with a finger 152 or the like.

A specific example of the lever operating gesture information is gesture information indicative of an operation of touching either of the lever display regions 251A and 251B.

Another specific example of the lever operating gesture information is gesture information indicative of an operation of touching both of the lever display regions 251A and 251B substantially simultaneously or within a certain time period.

The above gesture may be a single touch or a double touch, and may be changed as appropriate.

In the case where the state shifting section 11A has accepted lever operating gesture information, the addition/deletion accepting state display section 12A causes the display section 121 to display, as illustrated in FIG. 19, a screen indicating that the electronic notebook function section 142A is in the addition/deletion mode.

Specifically, as illustrated in FIG. 19, the addition/deletion accepting state display section 12A displays (i) in each of the lever display regions 251A and 251B, an image of a lever pressed down and (ii) in the ring display region 250 located along the left edge of the screen, an image of open loose-leaf rings. In this state, the deletion accepting section 13 accepts deletion gesture information, whereas the addition accepting section 16 accepts addition gesture information. The addition and deletion of a sheet are as described above, and are thus not described here.

In the case where the state shifting section 11A has accepted further lever operating gesture information in the above state, the electronic notebook function section 142A shifts to the state of FIG. 18 in which the rings are closed.

(Conclusion)

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

The above description deals with an example in which respective blocks of each of the electronic notebook devices 100 and 100A, particularly the electronic notebook function sections 142 and 142A, are each realized by software with use of a CPU.

The electronic notebook devices 100 and 100A each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting, to the electronic notebook devices 100 and 100A, a computer-readable storage medium containing control program code (executable program, intermediate code program, or source program) for the electronic notebook devices 100 and 100A, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (registered trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The electronic notebook devices 100 and 100A may each be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (registered trademark), 802.11 wireless, HDR, mobile telephone network, satellite line, or terrestrial digital network. The respective blocks of each of the electronic notebook devices 100 and 100A may be realized by way of hardware.

(Supplemental Notes)

The present invention can be described as follows: An information processing device of the present invention is an information processing device for, in response to an input operation performed with respect to a touch panel integrated with a display section, displaying electronic information as a page in the display section, the information processing device including: input operation detecting means for detecting an input operation performed with respect to a vicinity of, among sides of the page of the electronic information displayed, a first side on which the page is bound; and page processing means for carrying out a process of either page addition or page deletion in a case where after the input operation detecting means has detected the input operation, the page processing means has detected a predetermined input operation.

A method of the present invention for controlling an information processing device is a method for controlling an information processing device for, in response to an input operation performed with respect to a touch panel integrated with a display section, displaying electronic information as a page in the display section, the method including the steps of: (a) detecting an input operation performed with respect to a vicinity of, among sides of the page of the electronic information displayed, a first side on which the page is bound; and (b) carrying out a process of either page addition or page deletion in a case where after the step (a) has detected the input operation, a predetermined input operation has been detected.

The above arrangements each first detect an input operation performed with respect to the vicinity of, among the sides of a page of electronic information displayed, the side on which the page is bound.

The above input operation refers to an operation that can be recognized on a touch panel. Examples of the input operation include a click, a flick, a drag, and a swipe.

In the case where the information processing device displays electronic information as a page in the display section, the page displayed has a side representative of the side on which the page is bound. The expression “representative of the side on which the page is bound” means displaying an image that imitates the side of a paper notebook or book on which side the individual pages are bound.

The information processing device displays pages that imitate those of a paper notebook or book, and can thus provide an intuitive user interface.

The input operation performed with respect to the vicinity of the side on which the page is bound is representative of the action of releasing a bound page from a binding section. There are more than one feasible technique for releasing a bound page from a binding section. In other words, the technique varies depending on the method for binding a page. No matter what technique is used, however, an operation of some sort will be performed with respect to the page binding side.

For instance, one way to cut a page off a bound book as a paper medium is cutting, with use of a cutting tool or the like, the target page along the side on which that page is bound. The input operation performed with respect to the vicinity of the side on which the page is bound is thus, for example, an input operation performed in the direction along the page binding side.

The input operation performed in the direction along the page binding side, stated differently, corresponds to the action of tracing the gutter of a paper notebook or book at which gutter the individual pages are bound, and is a gesture of cutting a portion of a page at which portion the page is joined to the rest.

As another example, to replace loose leaves in a loose-leaf notebook, a ring-shaped fastening is opened with use of levers provided at the respective ends of the fastening.

The input operation performed with respect to the vicinity of the side on which the page is bound can thus be, for example, an input operation performed with respect to the ends of the page binding side. The “ends” may refer to both of the ends of the page binding side or to one of the ends of the page binding side.

In other words, the input operation performed with respect to the ends of the page binding side is representative of an operation of levers of a loose-leaf notebook.

The above input operations each suggest influencing a page in its entirety, particularly removing and inserting a page, and are thus convenient for the user in experiencing a sense of starting a process on a page in its entirety such as addition and deletion of a page.

The above arrangements, after detecting an input operation performed with respect to the vicinity of the side on which the page is bound, that is, after detecting a gesture of cutting a portion of a page at which portion the page is joined to the rest, each carry out a process of page addition or page deletion in the case where a predetermined input operation has been detected.

The predetermined input operation is, for example, an operation so set in advance as to start a process of page addition or page deletion, and is not particularly limited in arrangement. The predetermined input operation may be an operation that allows the user to experience a sense of (i) moving a page from the notebook body, (ii) adding or deleting a page to or from the notebook body, or (iii) replacing pages.

The predetermined input operation may be, as another example, an input operation performed in a direction substantially perpendicular to the page binding side. The input operation performed in a direction substantially perpendicular to the page binding side is representative of the action of (i) tearing a page off a paper notebook or book in the direction away from the page binding side or (ii) inserting a page in a paper notebook or book. The direction substantially perpendicular to the page binding side may thus have a variation range within which an input operation is recognized as having been performed with the intention of performing the gesture of (i) tearing a page away from the page binding side or (ii) inserting a page.

The process of page addition or page deletion is, to be specific, a process of (i) deleting electronic information for the currently display page or (ii) adding a new page. The process of page addition or page deletion additionally includes a process of temporarily removing the currently display page and adding the removed page to another position.

The above arrangements, which can carry out a process of page addition or page deletion in response to an input operation described above, each allow the user to experience, in operating the information processing device, a feeling of actually inserting or removing a page to or from a paper notebook or book.

As described above, the information processing device is arranged to add or delete a page in response to (i) a gesture of separating a page by cutting a portion of the page at which portion the page is joined to the rest and (ii) an input operation performed subsequently to the above gesture in a direction substantially perpendicular to the page binding side. This can provide a user interface that allows the user to delete a page through an intuitive operation similar to the action of actually inserting or removing a page to or from a paper notebook or book.

In addition, the above arrangements, which provide a user interface that allows the user to perform an operation of page deletion through two steps as described above, also each advantageously prevent the user from accidentally performing an unintended process. The above arrangements can, for instance, prevent the user from deleting a page by mistake.

The information processing device of the present invention may preferably be arranged such that the page processing means carries out a process of deleting a currently displayed page in a case where the page processing means has detected an input operation performed in a direction that is substantially perpendicular to the first side and that extends away from the first side.

An input operation performed in a direction that is substantially perpendicular to the page binding side and that extends away from the page binding side imitates the action of moving a page away from the page binding side to separate the page off.

The information processing device deletes the currently display page in response to (i) a gesture of cutting a page off by cutting a portion of the page at which portion the page is joined to the rest and (ii) a gesture, performed subsequently to the above gesture, of moving the page away from the page binding side to separate the page as above.

The above page deletion specifically means, for example, removing a page from the display and also deleting electronic information for that page. The page deletion further includes in scope saving electronic information for the deleted page in a region (such as a so-called recycle bin provided by a file managing function) for temporary storage of deleted electronic information.

The above arrangement can provide a user interface that allows the user to delete a page through an intuitive operation similar to the action of actually removing a page from a paper notebook or book.

The information processing device of the present invention may preferably further include: deletion displaying means for, while the page processing means is carrying out the process of deleting the currently displayed page, carrying out a display indicating that the process of deleting the currently displayed page is being carried out; and deletion canceling means for, in a case where the deletion canceling means has detected an input operation while the deletion displaying means is carrying out the display, canceling the process by the page processing means of deleting the currently displayed page.

According to the above arrangement, the process of deleting electronic information for a page is carried out over a predetermined time period during which the above display is carried out. The above display refers to, for example, a display effect of a page being torn or turned over to be separated.

The above arrangement allows the user to, while the above display is being carried out, perform an input operation for interrupting and canceling the deletion process.

The user may want to cancel a deletion process while the deletion process is being carried out. The above arrangement can meet such a want of the user's.

The information processing device may be arranged to cancel a deletion process upon detection of an input operation performed with respect to an image of a display effect indicating that the deletion process is being carried out. This arrangement provides a user interface that is easily understood by the user because of the user's motivation to prevent the deletion process by acting against the display of the deletion process being carried out.

The information processing device of the present invention may preferably be arranged such that the page processing means carries out a process of adding a new page in a case where the page processing means has detected an input operation performed in a direction that is substantially perpendicular to the first side and that extends toward the first side.

As described above, in a loose-leaf notebook as an actual stationery tool, a loose leaf may be removed or inserted when a ring-shaped fastening of the loose-leaf notebook is open.

The above arrangement allows the user to experience, in adding a new page, a feeling similar to the action of actually replacing loose leaves. The above arrangement can thus provide a user interface that the user can use intuitively.

The above addition of a new page specifically means, for example, not only adding a page and updating the display but also adding electronic information for the new page.

The information processing device of the present invention may preferably further include: accepting state display means for, in a case where the input operation detecting means has detected the input operation, displaying, along the first side, an image indicating that the page processing means accepts a process carried out for the process of either page addition or page deletion.

The above arrangement can inform the user that the information processing device is ready to delete electronic information for the currently display page or add a new page. Further, the above arrangement displays, along the page binding side, an image indicating that the user can perform an operation of adding a new page or deleting the currently display page. The above arrangement thus allows the user to recognize that the user's input operation has set the information processing device to a state in which the information processing device can carry out a process of adding or deleting a page.

The information processing device may display the above image in contact with or as separated from the page binding side. In other words, the information processing device simply needs to display the above image near the page binding side.

The above image preferably allows the user to understand that a further input operation will influence a page in its entirety. The above image is, for example, of a cutoff line.

The information processing device of the present invention may preferably be arranged such that the accepting state display means displays, as the image, an image in which a fastening for binding the page which fastening is initially closed becomes open.

A loose-leaf notebook is a stationery tool that includes a ring-shaped fastening for binding individual loose leaves. A loose-leaf notebook as an actual stationery tool allows its fastening for binding individual loose leaves to be closed and opened so that a loose leaf can be inserted or removed.

The above arrangement allows the user to experience a feeling similar to the action of actually replacing loose leaves. The above arrangement can thus provide a user interface that the user can use intuitively.

The information processing device of the present invention may preferably further include: a deleted page retaining section for retaining electronic information of the page that the page processing means has deleted; and state recovering means for, in response to a predetermined input operation, undeleting the electronic information retained by the deleted page retaining section.

The above arrangement allows deleted electronic information for a page to be retained instead of being completely deleted from the information processing device, and thus allows the user to recover such retained electronic information at any timing. In the case where the user has deleted electronic information for a page by mistake or needs electronic information for a page after deleting the page, the user can recover such electronic information for a deleted page.

### INDUSTRIAL APPLICABILITY

The present invention provides an intuitive interface for page deletion and the like to an electronic notebook device for displaying electronic information as a page. The present invention includes a touch panel interface, and is thus widely and suitably applicable to a tablet PC, a portable terminal and the like each having an electronic notebook function.

### REFERENCE SIGNS LIST

11, 11A state shifting section (input operation detecting means)
12 deletion accepting state display section (accepting state display means)
12A addition/deletion accepting state display section
13 deletion accepting section (page processing means)
14 page deleting section (page processing means, deletion displaying means, state recovering means)
15 deletion cancellation instructing section (deletion canceling means)
16 addition accepting section (page processing means)
17 page adding section (page processing means)
100, 100A electronic notebook device (information processing device)
120 touch panel section
121 display section
122 position input section (touch panel)
130 storage section
131 electronic notebook information storage section
132 deleted page retaining section
140 main control section
141 application section
142, 142A electronic notebook function section
151 touch pen
152 finger
202 edit region
220 region
230 cutoff line
240 ring display region

1. An information processing device for, in response to an input operation performed with respect to a touch panel integrated with a display section, displaying electronic information as a page in the display section,
the information processing device comprising:
input operation detecting means for detecting an input operation performed with respect to a vicinity of, among sides of the page of the electronic information displayed, a first side on which the page is bound; and
page processing means for carrying out a process of either page addition or page deletion in a case where a predetermined input operation has been detected after the input operation detecting means has detected the input operation.

2. The information processing device according to claim 1,
wherein:
the page processing means carries out a process of deleting a currently displayed page in a case where an input operation has been detected which has been performed in a direction that is substantially perpendicular to the first side and that extends away from the first side.

3. The information processing device according to claim 2, further comprising:
deletion displaying means for, while the page processing means is carrying out the process of deleting the currently displayed page, carrying out a display indicating that the process of deleting the currently displayed page is being carried out; and
deletion canceling means for, in a case where an input operation has been detected while the deletion displaying means is carrying out the display, canceling the process by the page processing means of deleting the currently displayed page.

4. The information processing device according to claim 1,
wherein:
the page processing means carries out a process of adding a new page in a case where an input operation has been detected which has been performed in a direction that is substantially perpendicular to the first side and that extends toward the first side.

5. The information processing device according to claim 1, further comprising:
accepting state display means for, in a case where the input operation detecting means has detected the input operation, displaying, along the first side, an image indicating that a process is ready to be accepted for carrying out for the process of either page addition or page deletion.

6. The information processing device according to claim 5,
wherein:
the accepting state display means displays, as the image, an image in which a fastening for binding the page which fastening is initially closed becomes open.

7. The information processing device according to claim 2, further comprising:
a deleted page retaining section for retaining electronic information of the page that the page processing means has deleted; and
state recovering means for, in response to a predetermined input operation, undeleting the electronic information retained by the deleted page retaining section.

8. A method for controlling an information processing device for, in response to an input operation performed with respect to a touch panel integrated with a display section, displaying electronic information as a page in the display section,
the method comprising the steps of:
(a) detecting an input operation performed with respect to a vicinity of, among sides of the page of the electronic information displayed, a side on which the page is bound; and
(b) carrying out a process of either page addition or page deletion in a case where a predetermined input operation has been detected after the step (a) has detected the input operation.
